(19) United States
(12) Patent Application Publication
(10) Pub. No.: US 2020/0169666 A1
(43) Pub. Date: May 28, 2020

(54) TARGET OBSERVATION METHOD, RELATED DEVICE AND SYSTEM

(71) Applicant: Autel Robotics Europe GmbH, Ismaning (DE)

(72) Inventor: Marcus GNOTH, Ismaning (DE)

(21) Appl. No.: 16/560,136

(22) Filed: Sep. 4, 2019

(30) Foreign Application Priority Data
Sep. 24, 2018 (DE) 102018123411.2

(51) Int. Cl. H04N 5/232; B64C 39/02; B64D 47/08; G05D 1/12; G05D 1/00; G05D 1/10

(52) U.S. Cl. CPC H04N 5/23293; H04N 5/23203; H04N 5/23299; B64C 39/024; B64D 47/08; B64C 2201/127; G05D 1/0038; G05D 1/101; B64C 2201/027; B64C 2201/146; G05D 1/12

(57) ABSTRACT

The present disclosure provides a target observation method, a related device and a system. The method includes: displaying, on a display screen of a remote control device, a target tracked by an unmanned aerial vehicle (UAV); determining, when a visual angle adjustment operation for the target that is input by a user into the remote control device is received, a visual angle adjustment parameter according to the visual angle adjustment operation; and adjusting an observation perspective for the target according to the visual angle adjustment parameter. This can simplify operations of the user during the adjustment of the observation perspective for the UAV and improve efficiency in the adjustment of the observation perspective for the target.

### CROSS-REFERENCE TO RELATED APPLICATION

This application claims priority of Germany Patent Application No. 102018123411.2, filed on Sep. 24, 2018, which is incorporated herein by reference in its entirety.

### BACKGROUND

### Technical Field

The present application relates to the field of unmanned aerial vehicle (UAV) technologies, and in particular, to a target observation method, a related device and a system.

### Related Art

With the development of UAV technologies, UAVs can implement various functions such as aerial photography, environment monitoring and scene investigation. A UAV may implement autonomous flight according to a preset route, or flight of a UAV is controlled by a remote control device, and the flight is performed according to an instruction sent by the remote control device. The remote control device may interact with a user, so that the UAV can fly according to an instruction of the user.

In some aerial photography scenarios, for example, in a scenario with a high requirement for photographing a target, joint efforts are needed to meet the aerial photography requirement. For example, one operator controls flight of a UAV by using a remote control, and another operator uses another remote control to control a camera on the UAV to perform a photography task. In this case, a plurality of operators needs to cooperate to implement the aerial photography task, and the operators are expected to have high control capabilities. During aerial photography by an aerial vehicle, if an observation perspective for a target needs to be adjusted, a user repeatedly performs operations, and efficiency in photographing a desired target image is low. Therefore, how to improve efficiency of adjusting the observation perspective for the target during the aerial photography by the aerial vehicle becomes a topic actively studied by a person skilled in the art.

### SUMMARY

Embodiments of the present application provide a target observation method, a related device and a system. This can simplify operations of a user during adjustment of an observation perspective for a UAV and improve efficiency in the adjustment of the observation perspective for a target.

According to a first aspect, an embodiment of the present application provides a target observation method, including:

displaying, on a display screen of a remote control device, a target tracked by a UAV;

determining, when a visual angle adjustment operation for the target that is input by a user into the remote control device is received, a visual angle adjustment parameter according to the visual angle adjustment operation; and

adjusting an observation perspective for the target according to the visual angle adjustment parameter.

Optionally, the determining, when a visual angle adjustment operation for the target that is input by a user into the remote control device is received, a visual angle adjustment parameter according to the visual angle adjustment operation includes:

determining location information of an expected observation point for the target when the visual angle adjustment operation for the target that is input by the user into the remote control device is received; and

determining the visual angle adjustment parameter according to the location information of the expected observation point.

Optionally, the determining the visual angle adjustment parameter according to the location information of the expected observation point includes:

determining an observation path of the UAV for the target according to the location information of the expected observation point, and using the observation path as the visual angle adjustment parameter.

Optionally, the method further includes:

displaying, on the display screen of the remote control device, a position relationship between the UAV and the target or the expected observation point.

Optionally, the position relationship includes at least one of the following: a distance, an azimuth, a height and a degree of inclination.

Optionally, the adjusting an observation perspective for the target according to the visual angle adjustment parameter includes:

adjusting the observation perspective for the target according to the visual angle adjustment parameter and a location of the target and/or a flight state of the UAV.

Optionally, the adjusting an observation perspective for the target according to the visual angle adjustment parameter includes:

determining a flight path of the UAV according to the visual angle adjustment parameter; and

controlling the UAV to fly according to the flight path, to adjust the observation perspective for the target.

Optionally, the adjusting an observation perspective for the target according to the visual angle adjustment parameter includes:

controlling, according to the visual angle adjustment parameter, a photographing perspective of a camera carried by the UAV for photographing the target, to adjust the observation perspective for the target.

According to a second aspect, an embodiment of the present application provides a target observation system, including a remote control device and a UAV, where

the remote control device is configured to display, on a display screen, a target tracked by the UAV;

the remote control device is further configured to determine, when a visual angle adjustment operation for the target that is input by a user into the remote control device is received, a visual angle adjustment parameter according to the visual angle adjustment operation; and

the UAV is configured to adjust an observation perspective for the target according to the visual angle adjustment parameter.

Optionally, that the remote control device is configured to determine, when a visual angle adjustment operation for the target that is input by a user into the remote control device is received, a visual angle adjustment parameter according to the visual angle adjustment operation is the remote control device is specifically configured to:

determine location information of an expected observation point for the target when the visual angle adjustment operation for the target that is input by the user into the remote control device is received; and

determine the visual angle adjustment parameter according to the location information of the expected observation point.

Optionally, the determining, by the remote control device, the visual angle adjustment parameter according to the location information of the expected observation point includes:

determining an observation path of the UAV for the target according to the location information of the expected observation point, and using the observation path as the visual angle adjustment parameter.

Optionally, the remote control device is further configured to:

display, on the display screen, a position relationship between the UAV and the target or the expected observation point.

Optionally, that the UAV is configured to adjust an observation perspective for the target according to the visual angle adjustment parameter is the UAV is specifically configured to:

adjust the observation perspective for the target according to the visual angle adjustment parameter and a location of the target and/or a flight state of the UAV.

Optionally, that the UAV is configured to adjust an observation perspective for the target according to the visual angle adjustment parameter is the UAV is specifically configured to:

determine a flight path of the UAV according to the visual angle adjustment parameter; and

control the UAV to fly according to the flight path, to adjust the observation perspective for the target.

Optionally, that the UAV is configured to adjust an observation perspective for the target according to the visual angle adjustment parameter is the UAV is specifically configured to:

control, according to the visual angle adjustment parameter, a photographing perspective of a camera carried by the UAV for photographing the target, to adjust the observation perspective for the target.

According to a third aspect, an embodiment of the present application provides a remote control device. The remote control device includes a display screen, a user interaction device and a processor.

Components in the remote control device cooperate so that any method in the first aspect can be implemented.

According to a fourth aspect, an embodiment of the present application provides a computer readable storage medium. The readable storage medium is configured to store a computer program. When invoked, the computer program is configured to implement any method in the first aspect.

In the embodiments of the present application, a target tracked by a UAV may be displayed on a display screen of a remote control device, a visual angle adjustment operation for the target that is input by a user may be received on the remote control device, and a visual angle adjustment parameter may be determined according to the visual angle adjustment operation, so that an observation perspective for the target may be adjusted according to the visual angle adjustment parameter. In this process, control operations of the user for the UAV and a camera can be simplified, thereby improving aerial photography efficiency and accuracy.

### BRIEF DESCRIPTION OF THE DRAWINGS

FIG. 1 is a schematic diagram of a scenario in which a plurality of users manipulates a same UAV according to an embodiment of the present application;

FIG. 2 is a schematic flowchart of a target observation method according to an embodiment of the present application;

FIG. 3 is a schematic diagram showing that a user operates a remote control device according to an embodiment of the present application;

FIG. 4 shows several implementation forms (i.e. FIGS. 4A to 4C) of observation paths according to an embodiment of the present application;

FIG. 5 is a schematic flowchart of another target observation method according to an embodiment of the present application;

FIG. 6 is a schematic architectural diagram of a target observation system 600 according to an embodiment of the present application;

FIG. 7 is a schematic flowchart of still another target observation method according to an embodiment of the present application; and

FIG. 8 is a schematic module composition diagram of a target observation device 800 according to an embodiment of the present application.

### DETAILED DESCRIPTION

An application scenario involved in the embodiments of the present application is described first.

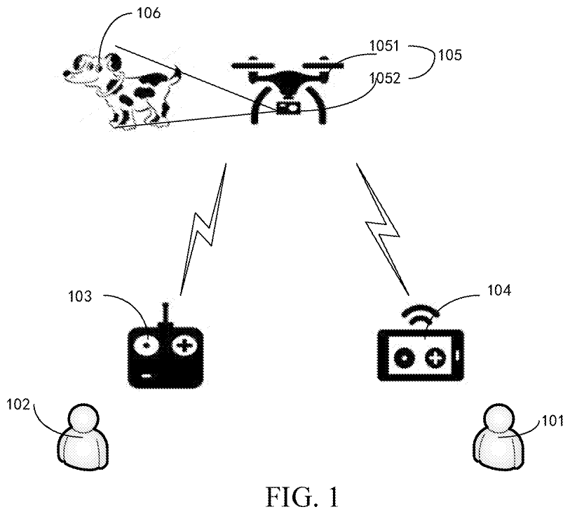

Referring to FIG. 1, FIG. 1 is a schematic diagram of a scenario in which a plurality of users manipulates a same UAV according to an embodiment of the present application.

As shown in FIG. 1, a user 102 may control, by using a remote control device 103, a body 1051 of a UAV 105 to fly. The body 1051 carries a camera 1052. The body 1051 may implement communication connection with the camera 1052. A user 101 may control, by using a remote control device 104, the camera 1052 of the UAV 105 to photograph. When a target 106 needs to be photographed, the user 102 controls, by using the remote control device 103, the UAV 105 to fly, and a user 101 needs to control the camera on the UAV to photograph. An aerial photography task can be implemented only in this way. When the aerial photography task includes photographing the target from an expected observation perspective, the user 102 and the user 101 need to cooperate to control the aerial vehicle to fly to a location and make the camera photograph the target from the expected observation perspective. In this process, the cooperation between the users and proficiency of the users in operating the UAV 105 both affect efficiency in adjusting the observation perspective for the target during the aerial photography by the UAV. Difficulty of the UAV in implementing the aerial photography task is increased.

For the problem in the scenario shown in FIG. 1, the following describes a target observation method, a related device and a system provided in the embodiments of the present application.

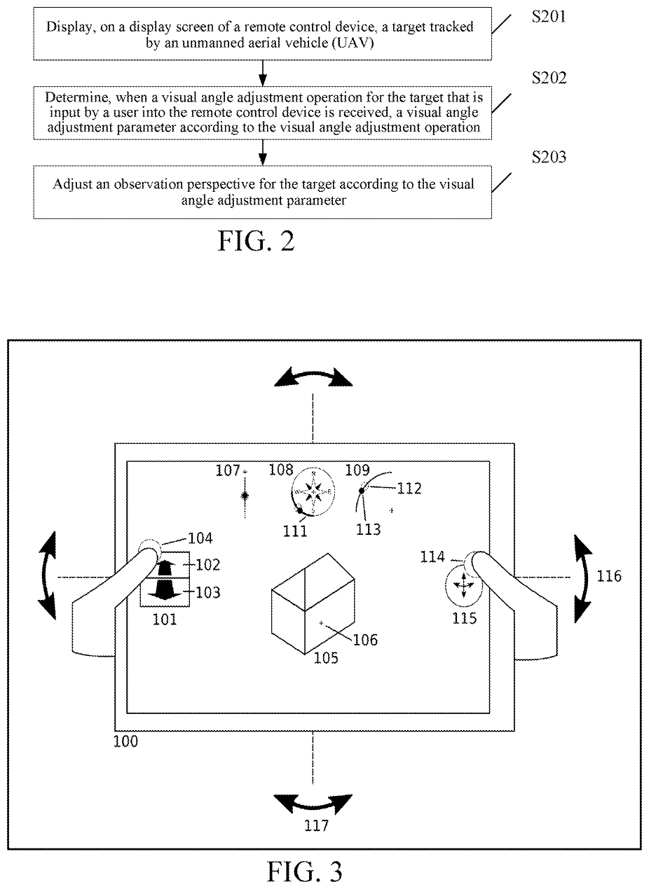

Referring to FIG. 2, FIG. 2 is a schematic flowchart of a target observation method according to an embodiment of the present application. As shown in FIG. 2, the target observation method includes the following steps:

Step S201. Display, on a display screen of a remote control device, a target tracked by a UAV.

Exemplarily, the UAV may send a photographed image to the remote control device in real time during flight. The remote control device may display in real time the image transmitted by the UAV. A user may determine the tracked target according to the displayed image and transmit a tracking instruction to the UAV by using the remote control device, so that the UAV tracks the target according to the tracking instruction and transmits an image of the tracked target to the display screen of the remote control device for display.

Exemplarily, the tracking instruction sent by the remote control device to the UAV may carry a feature or coordinates of the target, so that the UAV can automatically track the target according to the feature or coordinates of the target carried in the tracking instruction in combination with a target identification algorithm and a tracking algorithm. Alternatively, the tracking instruction sent by the remote control device to the UAV is used to control the flight of the UAV, so that the UAV flies according to the tracking instruction, thereby implementing tracking of the target.

Alternatively, the UAV may automatically track the identified target based on the target identification algorithm and the tracking algorithm and transmit in real time an acquired target image to the remote control device for display, so that the user can observe a status of the target.

Step S202. Determine, when a visual angle adjustment operation for the target that is input by a user into the remote control device is received, a visual angle adjustment parameter according to the visual angle adjustment operation.

Exemplarily, an interaction device used for interacting with a user or an input apparatus capable of receiving an operation input by a user may be configured in the remote control device. The operation input by the user may be one or more of a gesture operation, a touch control operation, a button operation (including a physical button and a virtual button on a touchscreen) and an attitude adjustment operation for the remote control device.

For example, referring to FIG. 3, FIG. 3 is a schematic diagram showing that a user operates a remote control device according to an embodiment of the present application. As shown in FIG. 3, a display interface of a remote control device 100 may display a target 105, and optionally, may further display coordinates of the target. The coordinates of the target may be coordinates of a center point of the target. This is not limited herein.

Further, the display interface of a touchscreen of the remote control device 100 may display a distance control 101. The distance control may include a distance reduction button 102 and a distance addition button 103. A user may input a visual angle adjustment operation by clicking or pressing a distance reduction button 102. The visual angle adjustment operation indicates that the user intends to reduce a distance between a UAV and a target. Similarly, the user may input a visual angle adjustment operation by clicking or pressing the distance addition button 103. The visual angle adjustment operation indicates that the user intends to add the distance between the UAV and the target. 104 may be used to indicate a specific touch control operation of the user on the touchscreen, such as a clicking operation, a sliding operation or a pressing operation. Alternatively, 104 may be construed as a distance unlock button. The user needs to first operate the distance unlock button 104, to unlock an operation state of the distance adjustment control 101. If the unlock button 104 is in a locked state, the user cannot operate the distance adjustment control 101, so that the user is prevented from incorrectly operating the remote control device.

Further, the user may input a visual angle adjustment operation by adjusting an angle of inclination of the remote control device. For example, the user may operate the remote control device to rotate around a horizontal axis 116. The remote control device may detect, by using a sensor such as a gravity acceleration sensor or a gyroscope, that the remote control device rotates around the horizontal axis 116, and then may acquire an angle of the rotation of the remote control device around the horizontal axis 116. Herein, the visual angle adjustment operation input by the user indicates a height of the UAV relative to the target or a degree of inclination of the UAV relative to the target that the user intends to adjust. For another example, the user may operate the remote control device to rotate around a vertical axis 117. The remote control device may sense the operation of the user, and may learn that the operation of the user is used to adjust an azimuth between the UAV and the target.

Optionally, the display interface of the remote control device may further display a tilt unlock button. The user first operates the tilt unlock button, to unlock a tilt operation of the user. In this way, the remote control device can sense a tilt state of a body, to determine the visual angle adjustment operation input by the user.

Certainly, the input operation of the user for the remote control device may further include another manner. For example, the user may determine an expected observation point for the target by using a map that includes the target and that is displayed on the display interface of the remote control device. The user may input coordinates or the like of the expected observation point by using a button or an input control of the remote control device. This is not limited herein.

After the visual angle adjustment operation of the user is received, a visual angle adjustment parameter for the target is determined according to the visual angle adjustment operation.

In an implementation, the visual angle adjustment parameter may include a specific adjustment parameter, for example, a distance (which may also be construed as a sighting distance) between the UAV and the target, an azimuth of the UAV relative to the target, an allowed azimuth range, a height, a degree of inclination or another parameter. For example, a parameter value of the visual angle adjustment parameter may be related to an operation degree of the visual angle adjustment operation. As shown in FIG. 3, if the user clicks or presses the distance reduction button 102, a value of the distance between the UAV and the target that needs to be adjusted may be determined according to the number of clicks or duration of the pressing performed by the user on the distance reduction button 102. Alternatively, if the user operates the remote control device to rotate around the horizontal axis 116, a height or an angle of inclination of the UAV may be determined according to an angle of the rotation.

In another implementation, location information of the expected observation point for the target may be determined according to the visual angle adjustment operation input by the user. For example, a point selected by the user on the map including the target may be determined as the expected observation point according to a clicking operation of the user on the map, and the location information of the expected observation point is calculated. Alternatively, the location information of the expected observation point of the user is determined according to spatial coordinates of an observation point directly input by the user.

Further, an observation path of the UAV for the target may be determined according to the determined location information of the expected observation point. For example, if the UAV is a fixed-wing aerial vehicle, the UAV cannot hover at the expected observation point to observe the target. Alternatively, the UAV flies according to the observation path, so that the target can be observed from a plurality of visual angles, thereby improving a success rate of aerial photography. In this case, the observation path of the UAV for the target may be determined according to the location information of the expected observation point. The observation path may include the expected observation point, or the observation path is close to the expected observation point. The observation path may be determined by the user, or obtained by using an algorithm in the remote control device or the UAV. There may be a plurality of forms of observation paths. Different forms of observation paths may be determined in different application scenarios. The observation path may alternatively be determined in another manner. This is not specified herein.

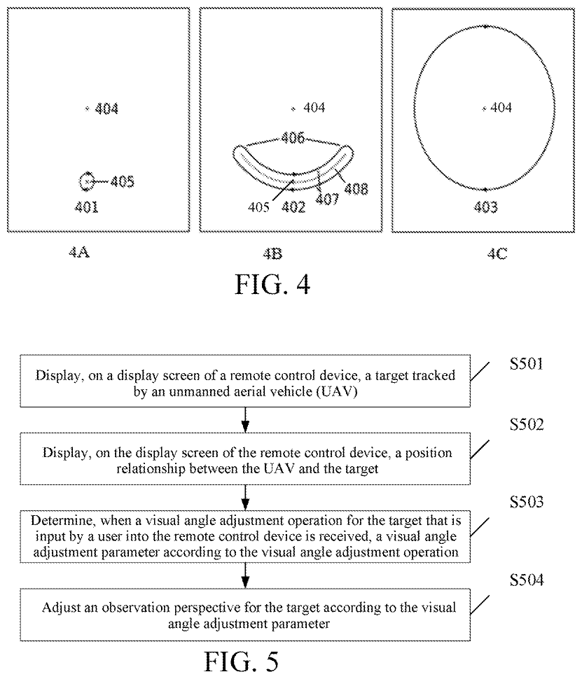

For example, referring to FIG. 4A to FIG. 4C, FIG. 4A to FIG. 4C show several implementation forms of observation paths according to an embodiment of the present application. The views in FIG. 4A to FIG. 4C representing the observation paths may be top views.

As shown in FIG. 4A, when it is determined that an allowed azimuth change range for observing a target is relatively low or is 0, or it is determined, according to a user operation or according to an environment, that a target needs to be observed only at the expected observation point, a radius as small as possible surrounding the expected observation point 401 may be determined. For example, a radius surrounding the expected observation point 401 is determined according to an environmental factor and a minimum value of the determined radius, and an observation path 405 is determined according to the radius, to observe the target 404. Certainly, the observation path 405 may alternatively be in another form. This is not limited herein.

As shown in FIG. 4B, when an allowed azimuth change range 408 for observing the target is determined, the UAV may fly in the allowed azimuth change range 408, and then an observation path 402 may be determined based on the allowed azimuth change range 408. The observation path 402 is formed by two arcs 407 along a horizontal direction of the allowed azimuth change range 408 and two minimum-radius turns 406, thereby implementing observation of the target in the allowed azimuth change range.

As shown in FIG. 4C, when it is determined that the allowed azimuth change range for observing the target is large enough, for example, when the user does not limit the allowed azimuth change range according to a visual angle adjustment operation, an observation path 403 surrounding the target 404 may be determined. If the allowed azimuth change range is large enough, the observation path 403 saves more flight time than the observation path 402 in FIG. 4B, thereby improving flight efficiency.

Exemplarily, step S202 may be implemented by the remote control device or may be jointly implemented by the remote control device and the UAV.

Specifically, the remote control device may receive a visual angle adjustment operation of the user for the target, and determine a visual angle adjustment parameter according to the visual angle adjustment operation. Alternatively, the remote control device receives a visual angle adjustment operation of the user for the target, and transmits the visual angle adjustment operation to the UAV in a form of an instruction. The UAV determines a visual angle adjustment parameter according to the visual angle adjustment operation.

Step S203. Adjust an observation perspective for the target according to the visual angle adjustment parameter.

Exemplarily, a control instruction for the UAV may be generated according to the visual angle adjustment parameter, to control the UAV to adjust the observation perspective for the target. Specifically, the control instruction may include a route instruction and a height instruction. The route instruction is used to indicate a flight direction, a flight speed or the like of the UAV. The height instruction is used to indicate a flight height of the UAV. If the visual angle adjustment parameter includes parameters such as a distance, an azimuth, an allowed azimuth change range, a height and a degree of inclination, the route instruction may be determined based on the parameters such as the distance, the azimuth and the allowed azimuth change range in the visual angle adjustment parameter. The height instruction may be determined based on the parameters such as the height and the degree of inclination. If the visual angle adjustment parameter includes the location information of the expected observation point, the route instruction and the height instruction may be determined based on latitude and longitude information and height information in the location information of the expected observation point.

Further, if the visual angle adjustment parameter includes the observation path for the target, the control instruction may control the UAV to move close to the expected observation point, and further control the UAV to fly according to the observation path.

Alternatively, a flight path of the UAV may be determined according to the visual angle adjustment parameter. Further, a specific route instruction and height instruction are determined according to the flight path of the UAV.

If the visual angle adjustment parameter includes the location information of the expected observation point for the target, a flight path through which the UAV flies to the expected observation point is determined according to the location information. Further, when the UAV flies to the expected observation point or flies close to the expected observation point, the observation path may be further determined. For example, the observation path is determined by using the allowed azimuth change range, and control information such as the specific route instruction and height instruction for the UAV is obtained according to the determined observation path.

Further, a photographing perspective of a camera used for photographing the target carried in the UAV may be controlled according to the visual angle adjustment parameter. For example, based on the azimuth in the visual angle adjustment parameter, the UAV may be controlled to adjust an attitude or an attitude of a gimbal connected to the camera may be controlled, to implement fine adjustment of the observation perspective of the UAV for the target, so that the observation perspective for the target is more accurate, thereby improving a success rate of aerial photography.

Further, the control instruction for the UAV or the flight path of the UAV is determined according to the visual angle adjustment parameter in combination with another factor.

Specifically, the observation perspective for the target may be adjusted according to the visual angle adjustment parameter, a location of the target, a flight state of the UAV, another requirement of the user or the like.

For example, a control instruction used for controlling a flight speed, a flight time and a flight direction of the UAV is determined according to the sighting distance in the visual angle adjustment parameter, the location of the target and a current location of the UAV. The observation perspective of the UAV for the target is adjusted by using the control instruction. For another example, a flight path close to the expected observation point may be determined according to the visual angle adjustment parameter, the location of the target or the flight state of the UAV. After the UAV completes the flight path, a flight path through which the UAV flies to the observation path is further determined according to the another requirement of the user. For example, a direct path through which the UAV flies to the observation path is calculated, so that the UAV can fly along the observation path as soon as possible. Alternatively, if the user desires not to fly on the target or hopes that a projection of the UAV on the ground when the UAV flies does not shadow the target, so that an aerial photography effect is not affected, another flight path is determined according to the user requirement, so that the UAV flies along the flight path to arrive at a point on the observation path and the target can be observed along the observation path. For example, a target image or video data or the like is acquired along the observation path.

Exemplarily, step S203 may be performed by the remote control device or the UAV or may be jointly implemented by the remote control device and the UAV.

When step S203 is performed by the remote control device, the remote control device may determine the control instruction for the UAV according to the visual angle adjustment parameter and send the control instruction to the UAV, so that the UAV directly flies according to the control instruction, that is, the control instruction does not need to be further processed, to adjust the observation perspective for the target.

When step S203 is performed by the UAV, the visual angle adjustment parameter may be determined by the UAV, or a flight control system or a navigation calculation system from the remote control device and the UAV may determine a flight mode, a flight path or an attitude adjustment of the UAV according to the visual angle adjustment parameter, to adjust the observation perspective for the target.

When step S203 is jointly performed by the remote control device and the UAV, that is, the remote control device determines the flight path of the UAV according to the visual angle adjustment parameter and sends the flight path to the UAV, so that the UAV can determine a specific control instruction according to the flight path, the observation perspective for the target is adjusted by controlling a power system, an electronic speed governor system or the like in the UAV.

Step S201 to step S203 may be repeatedly and cyclically performed.

In this embodiment of the present application, a target tracked by a UAV may be displayed on a display screen of a remote control device, a visual angle adjustment operation for the target that is input by a user may be received on the remote control device, and a visual angle adjustment parameter may be determined according to the visual angle adjustment operation, so that an observation perspective for the target may be adjusted according to the visual angle adjustment parameter. In this process, control operations of the user for the UAV and a camera can be simplified, thereby improving aerial photography efficiency and accuracy.

Referring to FIG. 5, FIG. 5 is a schematic flowchart of another target observation method according to an embodiment of the present application. As shown in FIG. 5, the method includes the following steps:

Step S501. Display, on a display screen of a remote control device, a target tracked by a UAV.

Step S502. Display, on the display screen of the remote control device, a position relationship between the UAV and the target.

For example, the display screen of the remote control device may display a tracking image for the target 105 transmitted by the UAV in real time, and may display the position relationship between the UAV and the target. As shown in FIG. 3, a window 107 may be used to display a real-time distance between the UAV and the target. For example, a filled dot in the window 107 may be used to indicate the UAV, and a pattern “+” may be used to indicate the target. The distance between the target and the UAV may be intuitively displayed by using the window 107. A window 108 may be used to display an azimuth and/or an allowed azimuth change range between the UAV and the target. For example, a filled dot displayed in the window 108 is used to indicate the UAV, and a pattern “+” is used to indicate the target. Optionally, the window 108 may display a compass. The window 108 may intuitively display a location of the UAV relative to the target. In this embodiment of the present application, the azimuth or the location of the UAV relative to the target is determined based on a horizontal reference plane of the target or a reference line in a horizontal plane. A window 109 may be used to display a height or a degree of inclination of the UAV relative to the target. For example, a filled dot 113 displayed in the window 109 is used to indicate the UAV, and a pattern “+” is used to indicate the target. An arc in 109 is used to indicate the height and the degree of inclination of the UAV relative to the target. That is, the arc may be used to indicate a flight trajectory of the UAV in a vertical plane. In this way, the height and the angle of inclination of the UAV relative to the target can be intuitively displayed by using the window 108. In the intuitive display manner, the user can intuitively determine an observation perspective of the UAV for the target, and can accurately input a visual angle adjustment operation when the observation perspective for the target needs to be adjusted, so as to improve efficiency and accuracy of visual angle adjustment during aerial photography.

Step S503. Determine, when a visual angle adjustment operation for the target that is input by a user into the remote control device is received, a visual angle adjustment parameter according to the visual angle adjustment operation.

Step S504. Adjust an observation perspective for the target according to the visual angle adjustment parameter.

For implementations of steps S501, S503 and S504, refer to the descriptions of the corresponding steps in the foregoing embodiments. Details are not described herein again.

Optionally, if the visual angle adjustment parameter includes location information of an expected observation point, the location information may be displayed by using a display interface of the remote control device. As shown in FIG. 3, each of dotted-line circles in the window 107, the window 108 and the window 109 may be used to indicate an expected observation point. In this case, after inputting a visual angle adjustment operation, the user can intuitively observe a position relationship between the UAV and an expected observation point and may further input an adjustment operation. Alternatively, when the user observes that the UAV is close to an expected observation point or arrives at an expected observation point, the user controls the UAV to perform an aerial photography task. In this way, accuracy of performing an aerial photography task by the UAV can be improved and a success rate of performing an aerial photography task by the UAV can also be improved.

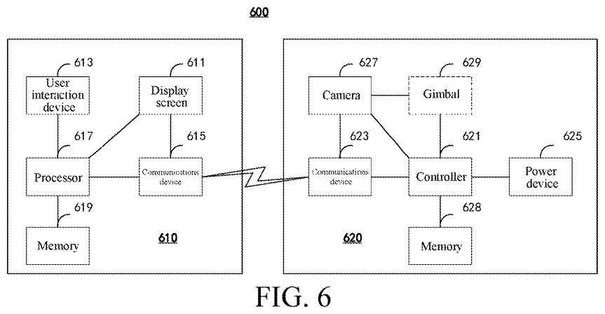

Referring to FIG. 6, FIG. 6 is a schematic architectural diagram of a target observation system 600 according to an embodiment of the present application. The target observation system 600 includes a remote control device 610 and a UAV 620.

The remote control device 610 may include a display screen 611, a user interaction device 613, a communications device 615, a processor 617 and a memory 619.

The display screen 611, the user interaction device 613, the communications device 615 and the memory 619 are connected to the processor 617. Alternatively, the components are connected to one another by using a bus. A manner of connection between the components may be implemented by a person skilled in the art using well-known technologies and is not limited herein.

The memory 619 may include a volatile memory, for example, a random-access memory (RAM), a static random-access memory (SRAM) or a double data rate synchronous dynamic random-access memory (DDR SDRAM). The memory 619 may alternatively include a non-volatile memory, for example, a flash memory, a hard disk drive (HDD), a solid-state drive (SSD) or an electrically erasable programmable read-only memory (EEPROM). The memory 619 may alternatively include a combination of the foregoing types of memories.

The memory 619 may be a stand-alone memory, or a memory inside a chip (for example, a processor chip) or a module having a storage function.

The memory 619 may store a computer program (for example, an application program or a functional module capable of implementing all or some of the methods of the embodiments of the present application), a computer instruction, an operating system, data, a database and the like. The memory 619 may store the foregoing items in a partitioned manner.

The processor 617 may be one or a combination of dedicated processors such as a central processing unit (CPU), a microprocessor, a network processor (NP), a data processor, an image processor and a task processor.

The processor 617 may further include a hardware chip. The hardware chip may be an application-specific integrated circuit (ASIC), a programmable logic device (PLD) or a combination thereof. The foregoing PLD may be a complex programmable logic device (CPLD), a field-programmable gate array (FPGA), a generic array logic (GAL) or any combination thereof. Certainly, the processor 617 may further include a hardware device such as a single-chip microcomputer.

The communications device 615 may include a wired communications interface and a wireless communications interface. The remote control device may communicate with a peripheral device by using the wired communications interface or the wireless communications interface. For example, the remote control device may communicate with the UAV 620 by using the wireless communications interface. The wireless communications interface may support various communication protocols, such as a 4th generation mobile communication protocol, a private communication protocol and a WiFi communication protocol, so that there may be various communication manners between the remote control device and the UAV.

The communications device 615 may transmit a control instruction, data or the like of the processor 617 to the UAV 620, or receive an image or data transmitted by the UAV 620 and transmit the received image or data to the processor 617, so that the processor 617 performs further transmission or processing on the image or data. Optionally, the communications device 615 may directly send the received image transmitted by the UAV 620 to the display screen 611 for display. This is not limited herein.

The display screen 11 may display the image or data transmitted by the processor 617 or may be connected to the communications device 615 to display the image or data transmitted by the communications device 615. The display screen 11 may further display at least one of the foregoing controls or windows.

The user interaction device 613 may receive an operation input by a user and then transmit the operation input by the user to the processor 617, so that the processor 617 may identify the operation input by the user input and may perform further processing on the identified user operation. The user interaction device 613 may include a touchscreen, a gesture detection device, a gyroscope, gravity decelerator, an image acquisition device or the like used for sensing a touch control operation, a gesture operation, an attitude operation or the like of a user.

Certainly, the remote control device 610 may further include other commonly used components or devices. No further details are provided herein.

The remote control device 610 may be used to implement any method in the foregoing embodiments. Alternatively, the remote control device 610 and the UAV 620 may jointly implement any method in the foregoing embodiments.

For example, that the remote control device 610 implements a method in the foregoing embodiments includes: the communications device 615 receives a target image acquired by the UAV when the UAV tracks a target, and transmits, directly or by using the processor 617, the target image to the display screen 611 for display. The user interaction device 613 may receive a visual angle adjustment operation for the target that is input by the user and may transmit a visual angle adjustment parameter to the processor 617. The processor 617 may determine the visual angle adjustment parameter according to the visual angle adjustment operation, and may determine a control instruction for the UAV 620 according to the visual angle adjustment parameter and transmit the control instruction to the UAV 620 by using the communications device 615, so that the UAV 620 flies according to the control instruction, thereby implementing adjustment of an observation perspective of the UAV 620 for the target. The control instruction sent by the remote control device 610 to the UAV 620 may be directly used to control operation of a power system in the UAV 620, to further directly achieve an expected adjustment effect of the user. Alternatively, the control instruction sent by the remote control device 610 to the UAV 620 needs to be processed by the UAV 620 to control operation of a power system, to achieve an expected adjustment effect of the user.

The UAV 620 may include a flight controller 621, a communications device 623, a power device 625, a camera 627 and a memory 628. Optionally, the UAV 620 may further include a gimbal 629. Certainly, the UAV 620 may further include other universal devices, such as a visual sensor, a radar, an inertial sensor, a power supply and an electronic speed governor. The UAV may further include a center body. The camera 627 may be connected to the center body by using the gimbal 627. Other devices may be disposed in the center body. The gimbal may be electrically connected to the flight controller 621, so that an attitude of the gimbal is adjusted under control of the flight controller 621 and further an attitude of the camera is adjusted.

An implementation of the communications device 623 may be the same as or different from that of the communications device 615 in the remote control device 610. This is not limited herein. Communication between the communications device 623 and the communications device 615 is implemented based on a communication protocol, to implement data or instruction communication between the remote control device 610 and the UAV 620. The communications device 623 may be construed as an image transmission system.

The camera 627 may be connected to the communications device 623 and the flight controller 621. There may be one or more cameras 627. The camera 627 may include various types of image acquisition devices such as a wide field camera, a high definition camera and an infrared camera. The camera 627 is configured to acquire image data or video data and may transmit the acquired image data or video data to the remote control device by using the communications device 623, for display on the display screen of the remote control device. Optionally, the gimbal 629 may be electrically connected to the flight controller 621, so that the attitude of the gimbal is adjusted under control of the flight controller 621 and further the attitude of the camera is adjusted. The camera 627 may further be connected to the memory 628, to store the acquired image data or video data into the memory 628.

For an implementation of the memory 628, refer to the implementation of the memory 619.

The flight controller 621 is connected to the communications device 623, the power device 625 and the camera 627. The flight controller 621 may be connected to the power device by using an electronic speed governor. This is not limited herein. The flight controller 621 may receive the control instruction or data from the remote control device 610 by using the communications device 623. The flight controller 621 may process the control instruction or data of the remote control device 610, to control the power device and control the UAV 620 to fly. The power device may include a motor, an airscrew, a ducted fan, a flap and the like. The flight controller 621 may further control the camera 627 to perform image acquisition. Alternatively, the flight controller 621 may identify a target in an image according to an image identification algorithm, to control the UAV to track the target.

The flight controller 621 may include one or a combination of dedicated processors such as a CPU, a microprocessor, an NP, a data processor, an image processor and a task processor.

The flight controller 621 may further include a hardware chip. The hardware chip may be an ASIC, a PLD or a combination thereof. The foregoing PLD may be a CPLD, an FPGA, a GAL or any combination thereof. Certainly, the flight controller 621 may further include a hardware device such as a single-chip microcomputer.

It should be noted that the UAV in this embodiment of the present application may be a fixed-wing UAV or a multi-rotor UAV, such as a quadrotor, a six-rotor or an eight-rotor UAV.

The memory 628 stores a program used for implementing some or all of the methods in the foregoing embodiments. The flight controller 621 may invoke the program in the memory 628 to implement some or all of the methods.

The following exemplarily describes a method performed by a target observation system. The target observation system includes the remote control device and the fixed-wing UAV described above.

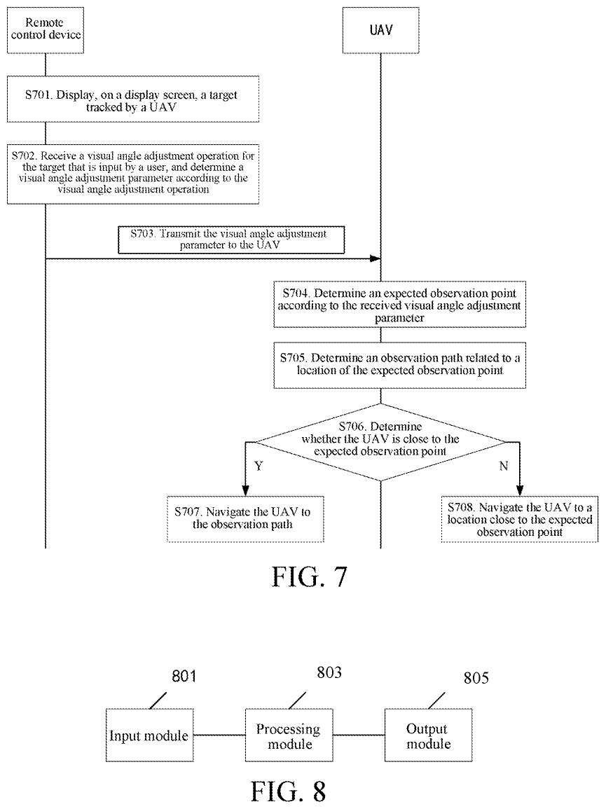

Referring to FIG. 7, FIG. 7 is a schematic flowchart of still another target observation method according to an embodiment of the present application. As shown in FIG. 7, the method includes the following steps:

Step S701. Display, on a display screen of a remote control device, a target tracked by a UAV.

Step S702. Determine, when a visual angle adjustment operation for the target that is input by a user into the remote control device is received, a visual angle adjustment parameter according to the visual angle adjustment operation. The visual angle adjustment parameter includes at least one of parameters such as a sighting distance, an azimuth, an allowed azimuth range, a height and a degree of inclination.

Step S703. The remote control device transmits the visual angle adjustment parameter to the UAV.

Step S704. The UAV determines an expected observation point according to the received visual angle adjustment parameter.

Step S705. The UAV determines an observation path related to a location of the expected observation point.

Step S706. The UAV determines whether the UAV is close to the expected observation point.

Exemplarily, the UAV may determine, according to a distance between a current location and the location of the expected observation point, whether the UAV is close to the expected observation point. For example, if the distance between the current location of the UAV and the location of the expected observation point is less than a preset threshold, it is determined that the UAV is close to the expected observation point.

Step S707. If yes, navigate the UAV to the observation path.

Exemplarily, if it is determined that the UAV is currently close to the expected observation point, navigation information for the UAV to the observation path may be generated, so that the UAV flies to the observation path according to the navigation information, and performs an aerial photography task along the observation path. The navigation information may be used to navigate the UAV to a point closest to the current location on the observation path. When arriving at the point, the UAV flies according to the observation path. Alternatively, the navigation information may be used to navigate the UAV to a start point on the observation path.

Step S708. If no, navigate the UAV to a location close to the expected observation point.

Exemplarily, if it is determined that the UAV is currently not close to the expected observation point, navigation information for the UAV to the expected observation point may be generated, so that the UAV flies close to the expected observation point according to the navigation information. The UAV may monitor whether a current location of the flight is close to the expected observation point, for example, monitor whether a distance between the current location of the UAV and the expected observation point is less than a preset threshold. If the distance is less than the threshold, the UAV may be further navigated to the observation path.

Further, the UAV may track the target according to the observation path and perform the aerial photography task, until the UAV receives the visual angle adjustment parameter sent by the remote control device.

The foregoing implementation can simplify adjustment of an observation angle for a target by the UAV according to a user requirement and improve adjustment efficiency.

An embodiment of the present application further provides a target observation device. The target observation device includes a plurality of functional modules. The plurality of functional modules may be disposed in a remote control device, or some functional modules are disposed in a remote control device and the remaining functional modules are disposed in a UAV.

Referring to FIG. 8, FIG. 8 is a schematic module composition diagram of a target observation device 800 according to an embodiment of the present application. The target observation device includes: an input module 801, a processing module 803 and an output module 805.

The output module 805 is configured to display, on a display screen of a remote control device, a target tracked by a UAV.

The input module 801 is configured to receive a visual angle adjustment operation for the target that is input by a user into the remote control device.

The processing module 803 is configured to determine a visual angle adjustment parameter according to the visual angle adjustment operation.

The processing module 803 is further configured to adjust an observation perspective for the target according to the visual angle adjustment parameter.

Optionally, the processing module 803 is specifically configured to:

determine location information of an expected observation point for the target when the visual angle adjustment operation for the target that is input by the user into the remote control device is received; and

determine the visual angle adjustment parameter according to the location information of the expected observation point.

Optionally, the processing module 803 is specifically configured to:

determine an observation path of the UAV for the target according to the location information of the expected observation point, and use the observation path as the visual angle adjustment parameter.

Optionally, the output module 805 is further configured to:

display, on the display screen of the remote control device, a position relationship between the UAV and the target or the expected observation point.

Optionally, the position relationship includes at least one of the following:

a distance, an azimuth, a height and a degree of inclination.

Optionally, the processing module 803 is specifically configured to:

adjust the observation perspective for the target according to the visual angle adjustment parameter and a location of the target and/or a flight state of the UAV.

Optionally, the processing module 803 is specifically configured to:

determine a flight path of the UAV according to the visual angle adjustment parameter; and

control the UAV to fly according to the flight path, to adjust the observation perspective for the target.

Optionally, the processing module 803 is specifically configured to:

control, according to the visual angle adjustment parameter, a photographing perspective of a camera carried by the UAV for photographing the target, to adjust the observation perspective for the target.

The foregoing functional modules may be implemented by software, or implemented by hardware, or implemented by software in combination with hardware. This is not limited herein.

An embodiment of the present application further provides a computer readable storage medium. The computer readable storage medium may be configured to store a computer program. When the computer program is executed, any method in the foregoing embodiments can be implemented. Optionally, the computer program may be modularized and different modules may be executed by different hardware devices. For example, the computer program may be jointly executed by the remote control device and the UAV. Correspondingly, after the computer program is modularized, different modules may be stored in computer readable storage mediums independent of each other. This is not limited herein.

Although the present application has been shown and described with reference to the exemplary embodiments of the present application, a person skilled in the art should understand that various changes in form and detail can be made to the present application without departing from the spirit and scope of the present application that are defined in the appended claims and the equivalent of the appended claims. Therefore, the scope of the present application should not be limited to the foregoing embodiments, but is defined by both the appended claims and the equivalent of the appended claims.

What is claimed is:

1. A target observation method, comprising:
displaying, on a display screen of a remote control device, a target tracked by an unmanned aerial vehicle (UAV);
determining, when a visual angle adjustment operation for the target that is input by a user into the remote control device is received, a visual angle adjustment parameter according to the visual angle adjustment operation; and
adjusting an observation perspective for the target according to the visual angle adjustment parameter.

2. The method according to claim 1, wherein the determining, when the visual angle adjustment operation for the target that is input by the user into the remote control device is received, the visual angle adjustment parameter according to the visual angle adjustment operation comprises:
determining location information of an expected observation point for the target when the visual angle adjustment operation for the target that is input by the user into the remote control device is received; and
determining the visual angle adjustment parameter according to the location information of the expected observation point.

3. The method according to claim 2, wherein the determining the visual angle adjustment parameter according to the location information of the expected observation point comprises:
determining an observation path of the UAV for the target according to the location information of the expected observation point, and using the observation path as the visual angle adjustment parameter.

4. The method according to claim 2, wherein the method further comprises:
displaying, on the display screen of the remote control device, a position relationship between the UAV and the target or the expected observation point.

5. The method according to claim 4, wherein the position relationship comprises at least one of the following:
a distance, an azimuth, a height and a degree of inclination.

6. The method according to claim 1, wherein the adjusting the observation perspective for the target according to the visual angle adjustment parameter comprises:
adjusting the observation perspective for the target according to the visual angle adjustment parameter and a location of the target and/or a flight state of the UAV.

7. The method according to claim 1, wherein the adjusting the observation perspective for the target according to the visual angle adjustment parameter comprises:
determining a flight path of the UAV according to the visual angle adjustment parameter; and
controlling the UAV to fly according to the flight path, to adjust the observation perspective for the target.

8. The method according to claim 1, wherein the adjusting the observation perspective for the target according to the visual angle adjustment parameter comprises:
controlling, according to the visual angle adjustment parameter, a photographing perspective of a camera carried by the UAV for photographing the target, to adjust the observation perspective for the target.

9. A target observation system, comprising a remote control device and an unmanned aerial vehicle (UAV), wherein
the remote control device is configured to display, on a display screen, a target tracked by the UAV;
the remote control device is further configured to determine, when a visual angle adjustment operation for the target that is input by a user into the remote control device is received, a visual angle adjustment parameter according to the visual angle adjustment operation; and
the UAV is configured to adjust an observation perspective for the target according to the visual angle adjustment parameter.

10. The system according to claim 9, wherein the remote control device is specifically configured to:
determine location information of an expected observation point for the target when the visual angle adjustment operation for the target that is input by the user into the remote control device is received; and
determine the visual angle adjustment parameter according to the location information of the expected observation point.

11. The system according to claim 10, wherein the remote control device is configured to:
determine an observation path of the UAV for the target according to the location information of the expected observation point, and use the observation path as the visual angle adjustment parameter.

12. The system according to claim 10, wherein the remote control device is further configured to:
display, on the display screen, a position relationship between the UAV and the target or the expected observation point.

13. The system according to claim 9, wherein the UAV is specifically configured to:
adjust the observation perspective for the target according to the visual angle adjustment parameter and a location of the target and/or a flight state of the UAV.

14. The system according to claim 9, wherein the UAV is specifically configured to:
determine a flight path of the UAV according to the visual angle adjustment parameter; and
control the UAV to fly according to the flight path, to adjust the observation perspective for the target.

15. The system according to claim 9, wherein the UAV is specifically configured to:
control, according to the visual angle adjustment parameter, a photographing perspective of a camera carried by the UAV for photographing the target, to adjust the observation perspective for the target.

16. A remote control device, comprising a display screen, a user interaction device and a processor, wherein
the display screen is configured to display a target tracked by an unmanned aerial vehicle (UAV);
the user interaction device is configured to receive a visual angle adjustment operation for the target that is input by a user;
the processor is configured to determine a visual angle adjustment parameter according to the visual angle adjustment operation; and
the processor is further configured to adjust an observation perspective for the target according to the visual angle adjustment parameter.
